(19) United States
(12) Patent Application Publication
(10) Pub. No.: US 2024/0395235 A1
(43) Pub. Date: Nov. 28, 2024

(54) ACTIVE NOISE CONTROL DEVICE FOR A VEHICLE AND A CONTROL METHOD THEREFOR

(71) Applicant: HYUNDAI MOBIS CO., LTD., Seoul (KR)

(72) Inventor: Hyung Sub LIM, Suwon-si (KR)

(73) Assignee: HYUNDAI MOBIS CO., LTD., Seoul (KR)

(21) Appl. No.: 18/665,706

(22) Filed: May 16, 2024

(30) Foreign Application Priority Data
May 24, 2023 (KR) 10-2023-0067131

(51) Int. Cl. G10K 11/178; B60N 2/00

(52) U.S. Cl. CPC G10K 11/17857; B60N 2/002; G10K 11/17879; G10K 2210/128

(57) ABSTRACT

An active noise control device including: a seat control device configured to sense a seated state inside a vehicle and control a seat displacement of each seat; a microphone disposed at any one place of a ceiling inside the vehicle to receive noise from the inside and outside of the vehicle and transmit an error signal; a plurality of acceleration sensors disposed on a transfer path for a vibration transferred to the vehicle to acquire a vibration causing noise on a road surface; an active noise control module configured to receive information on a seat displacement in a seated state from the seat control device and reference signals from the plurality of acceleration sensors, set an active noise target area, and generate an active noise control sound in the set active noise target area; and a speaker configured to output the active noise control sound.

### CROSS-REFERENCE TO RELATED APPLICATIONS

The present application claims the benefit under 35 USC § 119 (a) of Patent Application No. 10-2023-0067131, filed on May 24, 2023, in Korea, the entire disclosure of which is incorporated herein by reference for all purposes.

### TECHNICAL FIELD

The present disclosure relates to an active noise control device for a vehicle and a control method therefor.

### BACKGROUND

The content described in this section simply provides background information for the present disclosure and does not constitute related art.

In active noise control for a vehicle, noise control in a space inside the vehicle is performed on the basis of a position corresponding to an ear of an occupant. In the active noise control, a noise removal area may be tuned to be wide or may be tuned to be narrow. When the noise removal area is tuned to be wide, noise control performance deteriorates. On the other hand, when the noise removal area is tuned to be narrow, the noise control performance is improved. For this reason, it is important for the active noise control to include precisely determining an active noise target area corresponding to ears of the user.

A seat provided inside the vehicle may be moved forward and backward and up and down on the basis of settings of a user. Further, a backrest may recline or may be upright. Therefore, because an active noise control area corresponding to ears of the user changes depending on position information of the seat, there is a problem in that it is difficult to precisely estimate the active noise target area.

### SUMMARY

An active noise control device for a vehicle according to an embodiment can precisely estimate an active noise target area on the basis of position information of a seat using CAN communication.

The active noise control device for a vehicle according to an embodiment can improve active noise control performance without increasing manufacturing costs by using an existing configuration of the vehicle.

The problems to be solved by the present invention are not limited to the problems mentioned above, and other problems not mentioned may be clearly understood by those skilled in the art from the description below.

According to an embodiment, the active noise control device of a vehicle has an effect that the active noise control device of a vehicle can precisely estimate an active noise target area on the basis of position information of a seat using CAN communication.

According to an embodiment, the active noise control device for a vehicle has an effect that the active noise control device for a vehicle can improve active noise control performance without increasing manufacturing costs by using an existing configuration of the vehicle.

### BRIEF DESCRIPTION OF THE DRAWINGS

FIG. 1 is a diagram illustrating a configuration of an active noise control device according to an embodiment of the present disclosure.

FIG. 2 is a schematic diagram briefly illustrating a step of generating a transfer function of the active noise control device according to an embodiment of the present disclosure.

FIG. 3A is a diagram illustrating a state in which an active noise target area moves as a seat moves in a first direction or a second direction according to an embodiment of the present disclosure.

FIG. 3B is a diagram illustrating a state in which the active noise target area moves as the seat moves in a third direction or a fourth direction according to an embodiment of the present disclosure.

FIG. 3C is a diagram illustrating a state in which the active noise target area moves as the seat moves in a first rotation direction or a second rotation direction according to an embodiment of the present disclosure.

FIG. 4 is a diagram illustrating an embodiment in which active noise control is performed by determining the presence or absence of an occupant on a seat according to an embodiment of the present disclosure.

FIG. 5 is a flowchart illustrating an active noise control method according to an embodiment of the present disclosure.

### DETAILED DESCRIPTION

Hereinafter, some exemplary embodiments of the present disclosure will be described in detail with reference to the accompanying drawings. In the following description, like reference numerals preferably designate like elements, although the elements are shown in different drawings. Further, in the following description of some embodiments, a detailed description of known functions and configurations incorporated therein will be omitted for the purpose of clarity and for brevity.

Additionally, various terms such as first, second, A, B, (a), (b), etc., are used solely to differentiate one component from the other but not to imply or suggest the substances, order, or sequence of the components. Throughout this specification, when a part ‘includes’ or ‘comprises’ a component, the part is meant to further include other components, not to exclude thereof unless specifically stated to the contrary. The terms such as ‘unit’, ‘module’, and the like refer to one or more units for processing at least one function or operation, which may be implemented by hardware, software, or a combination thereof.

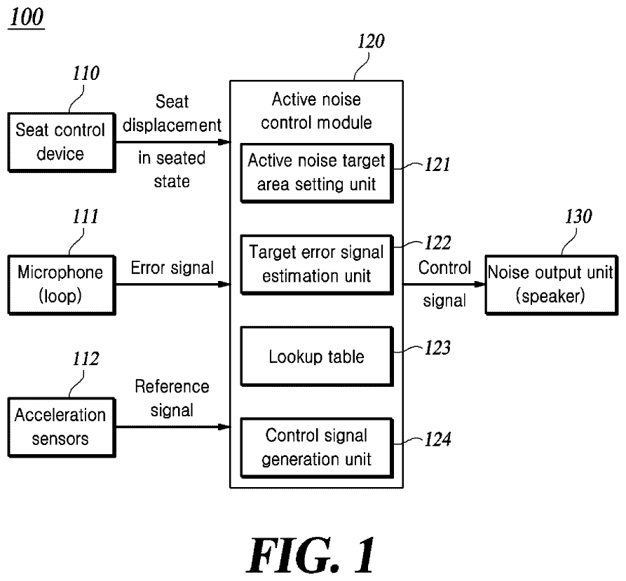

FIG. 1 is a diagram illustrating a configuration of an active noise control device according to an embodiment of the present disclosure.

Referring to FIG. 1, an active noise control device 100 includes some or all of a seat control device 110, a microphone 111, acceleration sensors 112, an active noise control module 120, and a noise output unit 130.

The seat control device 110 may sense a seating position of an occupant inside a vehicle 200.

The seat control device 110 may sense the seating position of the occupant using either a pressure sensor or a force sensor. The seat control device 110 senses information on a seat displacement in the seated state and transmits this information to the active noise control module 120.

The microphone 111 may be disposed in a first area and/or a second area inside the vehicle 200. The first area corresponds to an area of a ceiling inside the vehicle 200. The second area refers to an area corresponding to a position of a headrest of each seat 300.

The microphone 111 collects noise generated from the inside and outside of the vehicle 200, generates an error signal on the basis of (or based on) the collected noise, and transmits the error signal to the active noise control module 120.

The acceleration sensors 112 may sense noise caused by vibration, impact, or the like transmitted to the vehicle 200. The acceleration sensors 112 generate a reference signal on the basis of the sensed noise and transmit the generated reference signals to the active noise control module 120.

The acceleration sensors 112 may provide information on noise caused by vibration and impact that are transferred to the vehicle 200 when the active noise control module 120 performs the active noise control. The acceleration sensors 112 may measure vibration and shock of the vehicle 200 in real time. The active noise control module 120 may ascertain a vibration frequency and amplitude related to a cause of noise and perform the active noise control. The acceleration sensors 112 may be respectively attached to a chassis and/or engine of the vehicle 200.

When the vehicle 200 is traveling, the active noise control module 120 may receive data for road noise using the acceleration sensors 112 and the microphone 111, and selectively process the received data to construct and modify a database or map containing data and parameters to be used by the vehicle 200. The collected data may be stored in a local storage or in a cloud for future use.

The active noise control module 120 may include some or all of an active noise target area setting unit 121, a target error signal estimation unit 122, a lookup table 123, and a control signal generation unit 124.

The active noise target area setting unit 121 sets an active noise target area 211 defined through a predetermined experiment. That is, the active noise target area 211 according to an embodiment of the present invention is with reference to an area corresponding to the headrest of each seat 300, as described above. Therefore, a target area for which an active noise control sound is to be set is set on the basis of a position of the user seated on the seat 300.

The target error signal estimation unit 122 estimates an error signal corresponds to the target area previously stored in the lookup table 123, on the basis of information on the active noise target area 211 set by the active noise target area setting unit 121.

The lookup table 123 according to an embodiment of the present invention includes error signal information corresponds to a seat displacement of each seat 300 of the vehicle 200, an error signal received from the microphone 111, and a reference signal received from the acceleration sensors 112.

In the lookup table 123, the active noise target area 211 is changed depending on the displacement of each seat 300 of the vehicle 200, matched error signals between the changed active noise target area 211 and the microphone 111 are measured, and the measured error signals are mapped.

The active noise control device 100 according to an embodiment of the present invention may estimate the error signal received by the second noise collection device 210 by referring to the transfer function previously stored in the lookup table 123.

The control signal generation unit 124 generates a control signal for the estimated target area. Here, the control signal may include information on the active noise control sound.

The noise output unit 130 may be a speaker. The noise output unit 130 outputs an active noise control sound on the basis of the control signal generated by the control signal generation unit 124.

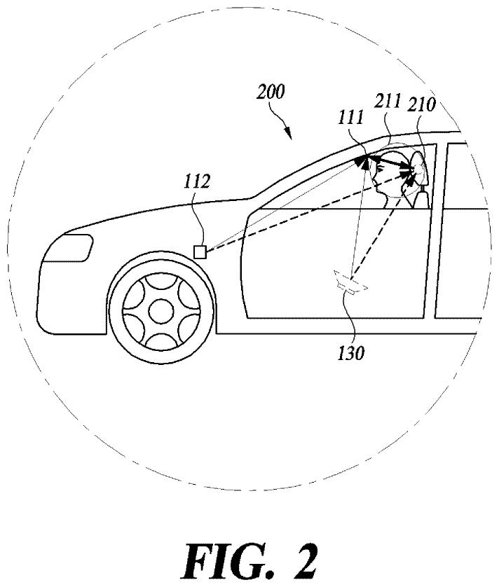

FIG. 2 is a schematic diagram briefly illustrating a step of generating a transfer function of the active noise control device according to an embodiment of the present disclosure.

Referring to FIGS. 1 and 2, the microphone 111 is disposed in the first area. The microphone 111 may be fixedly disposed in one area of the loop of the vehicle 200. The active noise target area 211 is disposed in the second area. The active noise target area 211 changes on the basis of a settings of the seat control device 110. The lookup table 123 may store transfer functions between the microphone 111 and the active noise target area 211 on the basis of a position of the active noise target area 211 set by the active noise target area setting unit 121.

The target error signal estimation unit 122 may estimate the error signal by referring to the transfer functions between the active noise target area 211 set by the active noise target area setting unit 121 and the microphone 111 from the lookup table 123.

Therefore, the active noise control device 100 may estimate the error signal in the active noise target area 211 using only noise information, that is, an error signal input to the microphone 111 using the lookup table 123.

The control signal generation unit 124 generates an active noise control signal on the basis of the active noise target area 211 set by the active noise target area setting unit 121 and the estimated error signal. The active noise control device 100 outputs the active noise control sound using the noise output unit 130, and collects data for the reproduced active noise control sound using the noise output unit 130. The active noise control sound reproduced by using the noise output unit 130 may include, for example, a basic tone such as a sine waveform or noise having various waveforms.

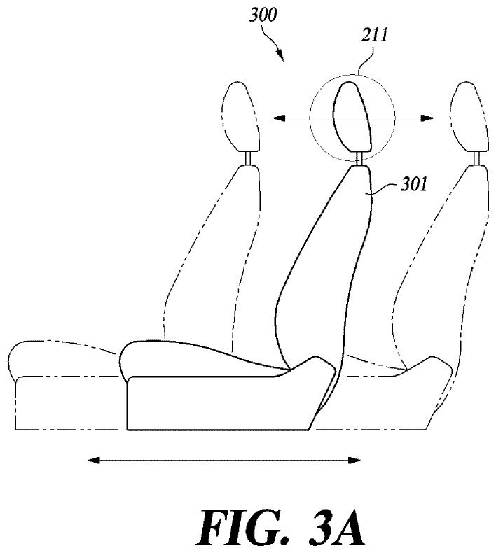

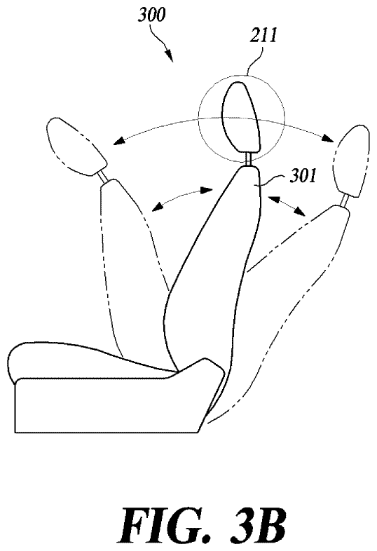

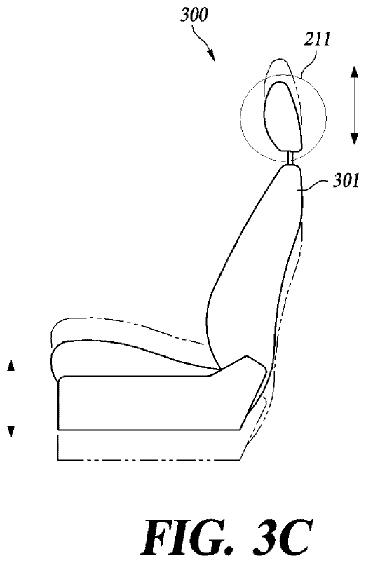

FIG. 3A is a diagram illustrating a state in which the active noise target area moves as the seat 300 moves in a first direction or a second direction according to an embodiment of the present disclosure.

B is a diagram illustrating a state in which the active noise target area moves as the seat 300 moves in a third direction or a fourth direction according to an embodiment of the present disclosure.

FIG. 3C is a diagram illustrating a state in which the active noise target area moves as the seat 300 moves in a first rotation direction or a second rotation direction according to an embodiment of the present disclosure.

Referring to FIG. 2 and FIGS. 3A to 3C, the active noise control device 100 according to an embodiment of the present invention is operated on the basis of CAN communication. Here, in the CAN communication, the displacement of the seat 300 disposed in the vehicle 200 and messages related thereto may be identified by analyzing a CAN network. Further, a CAN message related to a movement position of the seat 300 is checked and a data field of the message is interpreted. The data field may include information such as a position of the seat 300, a height of the seat 300, an angle of a backrest 301. In the CAN communication, position data of the seat 300 may be interpreted to estimate a relative position of the seat 300. For example, when the position data of the seat 300 is expressed as a number, the position of the seat 300 may be estimated by ascertaining the number. The estimated position data of the seat 300 may be integrated with other sensors or systems to increase accuracy. For example, the estimated position may be fed back to the active noise control module 120 using additional sensors, such as a position sensor and a pressure sensor for feeding back the seat displacement in the seated state of the seat 300. The active noise target area 211 changes on the basis of a movement direction of the seat 300. The active noise control module 120 may acquire information on the changed active noise target area 211 on the basis of the seat displacement in the seated state of the seat 300 provided using CAN communication. Here, the seat displacement in the seated state of the seat 300 refers to a posture of the seat 300 in a stopped state after the seat 300 has moved.

The seat 300 may move in the first direction or the second direction. The first direction is a direction in which the seat 300 moves forward. When the seat 300 moves forward on the basis of the first direction, the active noise target area 211 also moves forward in a direction parallel to the first direction. The second direction is a direction in which the seat 300 moves backward and is a direction opposite to the first direction. When the seat 300 moves backward on the basis of the second direction, the active noise target area 211 is also moved backward in a direction parallel to the second direction.

The seat 300 may move in the third direction or the fourth direction. The third direction is a direction in which the seat 300 moves up. When the seat 300 moves up on the basis of the third direction, the active noise target area 211 also moves up in a direction parallel to the third direction. The fourth direction is a direction in which the seat 300 moves down, and is a direction opposite to the third direction. When the seat 300 moves down on the basis of the fourth direction, the active noise target area 211 also moves down in a direction parallel to the fourth direction.

The backrest 301 of the seat 300 may be rotated in the first rotation direction or the second rotation direction. The first rotation direction is a direction in which the backrest 301 of the seat 300 is tilted back and reclines. When the backrest 301 of the seat 300 reclines on the basis of the first rotation direction, the position of the active noise target area 211 will also be rotated and moved on the basis of the same angle as the first rotation direction. The second rotation direction is a direction in which the backrest 301 of the seat 300 is tilted forward to be upright, and is a direction opposite to the first rotation direction. When the backrest 301 of the seat 300 is upright on the basis of the second rotation direction, the position of the active noise target area 211 will also be rotated and moved on the basis of the same angle as the second rotation direction. The seat displacement in the seated state of the seat 300 according to an embodiment of the present invention is not limited to the first to fourth directions, the first rotation direction, and the second rotation direction described above. The seat displacement in the seated state of the seat 300 may include both movement and rotation of the seat 300 in which the active noise target area 211 changes.

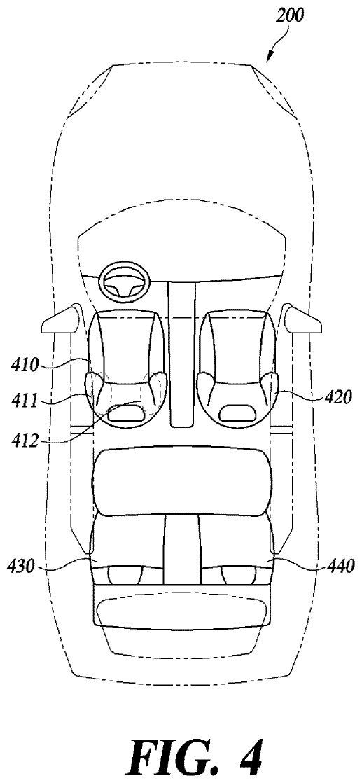

FIG. 4 is a diagram illustrating an embodiment in which active noise control is performed by determining the presence or absence of an occupant on the seat 300 according to an embodiment of the present disclosure.

Referring to FIGS. 2 to 4, assuming that the number of occupants that can board the vehicle 200 is 4 according to an embodiment of the present invention, the active noise control module 120 may determine whether or not the occupants are seated on four sensed seats 300 using the seat control device 110. For example, when the seat control device 110 determines that there is an occupant only on a left front seat 410 among the left front seat 410, a right front seat 420, a left rear seat 430, and a right rear seat 440, the active noise control module 120 may perform the active noise control using a left target area 411 and a right target area 412 of the left front seat 410. Here, the left target area 411 and the right target area 412 are areas formed near a headrest of the left front seat 410.

The target error signal estimation unit 122 may estimate the error signal previously stored in the lookup table 123 with reference to the target area set by the active noise target area setting unit 121.

The seat control device 110 according to another embodiment of the present invention determines that occupants board all the seats 300 among the left front seat 410, the right front seat 420, the left rear seat 430, and the right rear seat 440, the active noise control module 120 may refer to, for example, transfer functions corresponding to eight areas that are the left and right areas of the respective seats 300, from the lookup table 123. In this case, in the above-described embodiment, the control signal generation unit 124 may perform the active noise control by applying weights to the transfer functions referred to in the eight areas, which are the left target areas 411 and the right target areas 412 of the left front seat 410, the right front seat 420, the left rear seat 430, and the right rear seat 440, as compared to a case in which functions for two areas including the left target area 411 and the right target area 412 which are the active noise target areas of the left front seat 410 are generated.

The lookup table 123 stores a transfer function between the active noise target areas 211 that change on the basis of seat displacement in the seated state and the microphone 111 disposed in the first area.

Therefore, the active noise control device 100 according to an embodiment of the present invention may generate the active noise control sound by using the lookup table 123 in which a transfer function between the active noise target area 211, which is set on the basis of the seat displacement in the seated state, the error signal, and the reference signal, and the microphone 111 is stored.

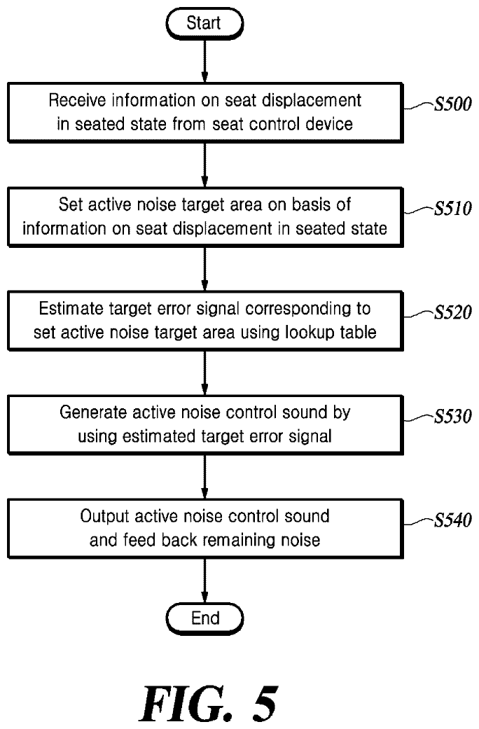

FIG. 5 is a flowchart illustrating an active noise control method according to an embodiment of the present disclosure.

Referring to FIG. 5, the active noise control module 120 receives information on seat displacement in the seated state from the seat control device 110 (S500).

The active noise control module sets the active noise target area on the basis of information on seat displacement in the seated state (S510).

A target error signal corresponding to the set active noise target area 211 is estimated using the lookup table 123 (S520).

The active noise control sound is generated by using the estimated target error signal (S530).

The active noise control sound generated using the noise output unit 130 is output, and remaining noise is fed back (S540).

Each element of the apparatus or method in accordance with the present invention may be implemented in hardware or software, or a combination of hardware and software. The functions of the respective elements may be implemented in software, and a microprocessor may be implemented to execute the software functions corresponding to the respective elements.

Various embodiments of systems and techniques described herein can be realized with digital electronic circuits, integrated circuits, field programmable gate arrays (FPGAs), application specific integrated circuits (ASICs), computer hardware, firmware, software, and/or combinations thereof. The various embodiments can include implementation with one or more computer programs that are executable on a programmable system. The programmable system includes at least one programmable processor, which may be a special purpose processor or a general purpose processor, coupled to receive and transmit data and instructions from and to a storage system, at least one input device, and at least one output device. Computer programs (also known as programs, software, software applications, or code) include instructions for a programmable processor and are stored in a “computer-readable recording medium.”

The computer-readable recording medium may include all types of storage devices on which computer-readable data can be stored. The computer-readable recording medium may be a non-volatile or non-transitory medium such as a read-only memory (ROM), a random access memory (RAM), a compact disc ROM (CD-ROM), magnetic tape, a floppy disk, or an optical data storage device. In addition, the computer-readable recording medium may further include a transitory medium such as a data transmission medium. Furthermore, the computer-readable recording medium may be distributed over computer systems connected through a network, and computer-readable program code can be stored and executed in a distributive manner.

Although operations are illustrated in the flowcharts/timing charts in this specification as being sequentially performed, this is merely an exemplary description of the technical idea of one embodiment of the present disclosure. In other words, those skilled in the art to which one embodiment of the present disclosure belongs may appreciate that various modifications and changes can be made without departing from essential features of an embodiment of the present disclosure, that is, the sequence illustrated in the flowcharts/timing charts can be changed and one or more operations of the operations can be performed in parallel. Thus, flowcharts/timing charts are not limited to the temporal order.

Although exemplary embodiments of the present disclosure have been described for illustrative purposes, those skilled in the art will appreciate that various modifications, additions, and substitutions are possible, without departing from the idea and scope of the claimed invention. Therefore, exemplary embodiments of the present disclosure have been described for the sake of brevity and clarity. The scope of the technical idea of the present embodiments is not limited by the illustrations. Accordingly, one of ordinary skill would understand that the scope of the claimed invention is not to be limited by the above explicitly described embodiments but by the claims and equivalents thereof.

What is claimed is:

1. An active noise control device comprising:
a seat control device configured to sense a seated state of one or more seats within a vehicle and control a seat displacement of each seat;
a microphone disposed at a ceiling of the vehicle and configured to receive noise from an inside and outside of the vehicle and transmit an error signal;
a plurality of acceleration sensors disposed on a transfer path through which a vibration is transferred to the vehicle and configured to acquire a vibration causing noise on a road surface;
an active noise control module configured to (1) receive information on the seat displacement in the seated state from the seat control device and a plurality of reference signals from the plurality of acceleration sensors, (2) set an active noise target area, and (3) generate an active noise control sound in the set active noise target area; and
a speaker configured to output the active noise control sound.

2. The active noise control device of claim 1, wherein the active noise control module includes:
an active noise target area setting unit configured to set the active noise target area based on the seat displacement of each seat in the seated state;
a lookup table including a transfer function between the plurality of acceleration sensors and the active noise target area;
a target error signal estimation unit configured to estimate an error signal in the active noise target area set using the lookup table; and
a control signal generation unit configured to generate an active noise control signal corresponding to the estimated error signal.

3. The active noise control device of claim 2, wherein the lookup table is a result of defining a transfer function between a plurality of active noise target areas formed based on a position of the microphone and the seat displacement of each seat in the seated state.

4. The active noise control device of claim 1, wherein the information on the seat displacement of each seat in the seated state includes:
information on a first direction in which the seat moves forward;
information on a second direction in which the seat moves rearward, the second direction being opposite to the first direction;
information on a third direction in which the seat moves up;
information on a fourth direction in which the seat moves down, the fourth direction being opposite to the third direction;
information on a first rotation direction in which a backrest of the seat reclines; and
information on a second rotation direction in which the backrest rotates to be upright, the second rotation direction being opposite to the first rotation direction.

5. An active noise control method comprising:
receiving information on a seat displacement of one or more seats in a seated state;
setting an active noise target area based on the information on the seat displacement of each seat in the seated state;
estimating an error signal in the active noise target area;
generating an active noise control signal based on the error signal in the active noise target area; and
generating and outputting an active noise control sound corresponding to the active noise control signal.

6. The active noise control method of claim 5, wherein setting the active noise target area based on the information on the seat displacement of each seat in the seated state includes receiving current position information of seats based on a CAN (controller area network) communication.

7. The active noise control method of claim 5, wherein setting the active noise target area based on the information on the seat displacement of each seat in the seated state includes:
sensing a presence or absence of one or more occupants in some or all of the seats; and
estimating the active noise target area of each seat based on the presence or absence of the sensed one or more occupants.

8. The active noise control method of claim 5, wherein generating the active noise control signal based on the error signal in the active noise target area includes generating the active noise control sound based on transfer functions between a microphone disposed in a first area of the vehicle and a plurality of active noise target areas disposed in a second area of the vehicle based on transfer functions previously stored in a lookup table.

9. The active noise control method of claim 8, wherein generating the active noise control sound based on the transfer functions between the microphone disposed in the first area of the vehicle and the plurality of active noise target areas disposed on the second area of the vehicle based on the transfer functions previously stored in the lookup table includes:
calculating an average value of the plurality of active noise target areas disposed in the second area or applying a weight to each of the plurality of active noise target areas disposed in the second area; and
generating a transfer function using a noise collection device disposed in the first area.

10. The active noise control method of claim 5, further comprising:
outputting, using a noise output device disposed within the vehicle, noise corresponding to the active noise control signal; and
performing active noise feedback on collected noise while outputting the active noise control signal.
